(19) United States
(12) Patent Application Publication
(10) Pub. No.: US 2003/0079220 A1
(43) Pub. Date: Apr. 24, 2003

(54) Method for allocating negotiable discount coupons to consumers using a distributed processing network

(76) Inventor: David Wayne Bruner, Provo, UT (US)

Correspondence Address: Angus C. Fox, III, 4093 N. Imperial Way, Provo, UT, 84604-5386, US

(21) Appl. No.: 09/982,632

(22) Filed: Oct. 18, 2001

(51) Int. Cl. H04N 7/16

(52) U.S. Cl. 725/23

(57) ABSTRACT

A convenient and secure method is provided via a distributed processing network, such as the Internet, for allowing consumers to personally print on security paper available only from the provider of the service selected discount coupons, which have been preauthorized by a provider of goods or services, on a restricted basis, and in a manner which makes counterfeiting of such coupons extremely difficult. The invention also provides a method for tracking the use of the coupons with an on-line accessible and updatable database, so that the buying habits of the consumers may be ascertained. The providers of the goods and services are allowed access to the database and are able to enter data related to the use of tendered coupons and view accumulated data and statistical analyses of that data.

### BACKGROUND OF THE INVENTION

1. Field of the Invention

The present invention relates to methods for printing discount coupons on a consumer-controlled printer and, more particularly, to a method for ensuring that the coupons that are printed are limited in number and not easily counterfeitable.

2. Description of the Prior Art

In the highly commercialized and competitive U.S. economy, businesses view negotiable discount coupons as a primary means of introducing new products and services to consumers, as well as a means for rekindling relationships between businesses and consumers. As a general rule, the more saturated an industry is from a economic supply perspective, the greater the proliferation of discount coupons. Typically, coupons for substantial discounts are offered for goods and services for which frequent repeat purchases are common. The highly-competitive restaurant industry is likely the largest provider of discount coupons. The primary goal of a discount coupon campaign is to introduce consumers, who are unfamiliar with an offered product or service, a low-risk opportunity to purchase the product or service. In other words, providers of products or services are willing to provide substantial discounts to consumers, often at close to cost, with the hope of enticing those consumers to try their product or service at a price which consumers find difficult to resist. The hope, of course, is that the consumer will be sufficiently impressed with the quality and value of the product or service so as to become a frequent repeat customer. A secondary goal is that of generating sufficiently large walk-in clientele so that the business has the appearance of success. The principal problem with discount coupon campaigns is that they tend to create a large pool of repeat customers who repeatedly take advantage of periodically-available coupons featuring deep discounts, which makes catering to that pool a losing, break-even or, at best, a low-margin proposition.

Many consumers have become addicted to discount coupons, and will only visit a business establishment if they can secure a substantial discount that is unprofitable to the provider of the goods or service. For this reason, fine restaurants with high overhead costs are reluctant to engage in the distribution of discount coupons. A two-for the price of one coupon at a high-end restaurant can—depending on the restaurant's location in the country—easily represent a discount of ten to one hundred dollars. Given the tremendous advances in copying technology over the past decade, the counterfeiting of deep-discount coupons is more than a theoretical problem.

What is needed is a convenient and secure system for providing deep-discount negotiable coupons to consumers on a restricted basis, and for also subsequently providing discount coupons for lesser amounts in order to increase the frequency of consumer purchases.

### SUMMARY OF THE INVENTION

A method is provided for restricting the distribution of negotiable discount coupons to individual consumers via a distributed processing network. The method is implemented by providing a server computer system accessible via the network. The server system is provided with a searchable database of discount offers, authorized by participating merchants, which may be applied to the purchase of specific goods and/or services. At least some of the offers are subject to restrictions imposed by the authorizing merchant with regard to the number of times a single consumer may take advantage of a particular discount offer.

The method also requires the establishment of a pool of registered subscribing member consumers, each of whom may access the server via a the network, using a client computer system, and obtain the information related to available discount offers. The client computer system may be a personal computer or internet appliance. The client computer system must be connected to a printer accessible to the consumer.

Various sheets of security paper are delivered to each of the subscribing consumers by a program manager, so that negotiable discount coupons may be printed by the consumer thereon. The security paper may have water marks, colored fibers, or other identifiable, but not easily duplicatable features. Each of the sheets is perforated in order to facilitate singulation of multiple coupons printed on a single sheet.

In order to accurately position the printing of the coupons on the provided security paper, the subscribing consumer is asked to calibrate his printer. Calibration is accomplished by having the consumer print a test pattern on a calibration sheet provided by the program manager. The test pattern consists of two pairs of intersecting lines, which represent the opposite corner locations of a rectangular, default-positioned-and-sized coupon printing field. The calibration sheet has a preprinted x-y grid, each axis of which includes a sequential scale of alphanumeric characters. With the test pattern printed and superimposed on the preprinted grid, the consumer is asked to identify the two corners in terms of the alphanumeric x-y coordinates. Once this information is available to the server, it can adjust the position and size of the coupon printing field. For a preferred embodiment of the invention, the calibration information is stored on the client system and uploaded to the server for each printing operation.

In response to a registered consumer's indicated interest in a particular offer, that consumer is allowed to download and print from the server system, on the security paper provided, and using a printer coupled to client system, negotiable discount coupons, each of which reflects an authorized discount offer, the number of coupons which may be printed by a single consumer for each authorized discount being limited in accordance with the restrictions imposed by the merchant.

The invention also provides a method for tracking the use of the coupons with an on-line accessible and updatable database, so that the buying habits of the consumer members may be ascertained. Each coupon is printed with both the name of the registered consumer and a unique serial number so that it may be individually tracked by the database. The serial number also affords additional security by allowing the merchant to verify whether or not the coupon's use is authorized under the terms of its discount program. The providers of the goods and services are allowed access to the database and are able to enter data related to the use of tendered coupons and view accumulated data and statistical analyses of that data. The statistical analyses afford the merchant the opportunity to better tailor its products and advertising to customer behavior. For example, the database identifies the consumer member by zip code, provides his sign-up date, and keeps track of member visit frequency, total ticket value after discount, as well as the discount type and amount.

### BRIEF DESCRIPTION OF THE DRAWINGS

FIG. 1 is a block diagram of a distributed processing network in which four client systems are configured to implement the present invention;

FIG. 2 is a sample of a sheet of security paper having five, contiguous, preprinted, blank discount coupons, each of which includes tear perforations at the outer perimeter thereof;

FIG. 3 is a sample printing of a test pattern on a preprinted calibration sheet;

FIG. 4 is a sample of a trial printout of five contiguous discount coupons, each of which has been made non-negotiable by printing the word VOID thereon;

FIG. 5 is a sample of a final printout of five contiguous discount coupons; and

FIG. 6 is a simplified block diagram of the discount program server, including programs and databases resident thereon.

### PREFERRED EMBODIMENT OF THE INVENTION

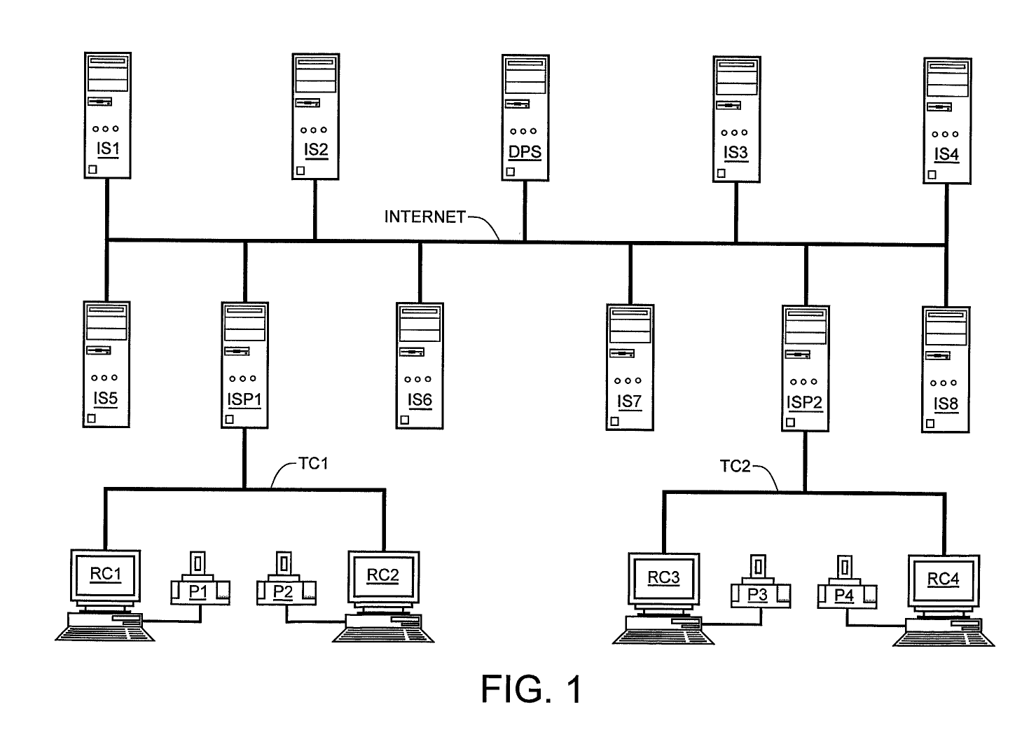

A method is provided for allocating the distribution of negotiable discount coupons to individual consumers via a distributed processing network. The method requires a program manager, a group of consumers who desire to acquire negotiable discount coupons, and merchants who are willing to provide discount offers, at least some of which are made available on a limited or restricted basis. The method will now be described with reference to the attached drawing FIGS. 1 through 5.

Referring now to FIG. 1, the method is implemented by providing a discount program server computer system DPS accessible via a distributed processing network 101, such as the Internet. The program server system DPS is provided with a searchable database (not shown in this drawing figure) of discount offers, authorized by participating merchants, which may be applied to the purchase of specific goods and/or services. At least some of the offers are subject to restrictions imposed by the authorizing merchant with regard to the number of times a single consumer may take advantage of a particular discount offer.

Still referring to FIG. 1, the method also requires the establishment of a pool of registered subscribing consumers, each of whom may access the server via a the network 101, using a client computer system RC1, RC2, RC3 or RC4, and obtain the information related to available discount offers. The client computer system may be a personal computer or internet appliance. Each client computer system RC1, RC2, RC3 and RC4 may be coupled to the network 101 in a variety of different ways. RC1 is coupled to internet service provider No. 1 server ISP1 via a dial-up telephone connection DTC; client systems RC2 and RC3 are coupled to server ISP1 and internet service provider No. 2 server ISP2, respectively, via the same cable network connection CNC, while client system RC4 is coupled to connected to ISP2 via a DSL connection DSL. Each client computer system RC1, RC2, RC3 and RC4 has associated therewith a printer P1, P2, P3 and P4, respectively. Also coupled to a typical distributed processing network 101, such as the internet, are multiple internet servers IS1, IS2, IS3, IS4, IS5, IS6, IS7 and IS8.

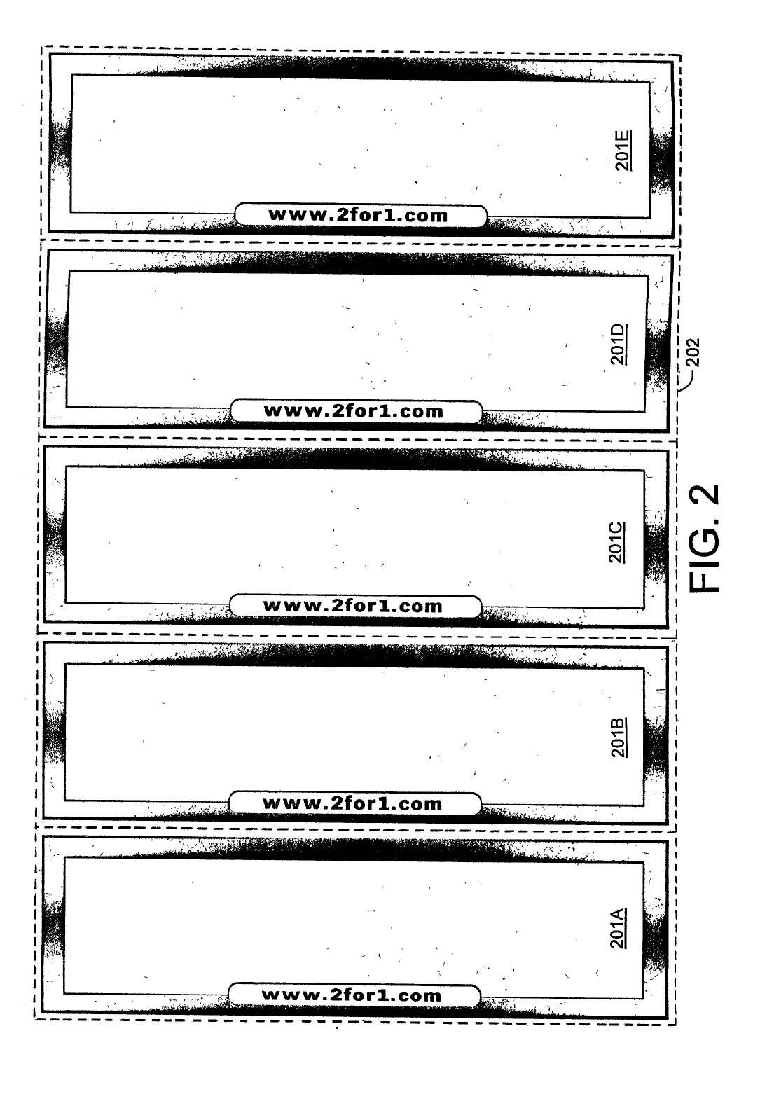

Referring now to FIG. 2, multiple sheets of security paper are delivered to each of the subscribing consumers by the program manager (in this particular case, www.2for1.com, inc.), so that negotiable discount coupons may be printed by the consumer thereon. The security paper may have water marks, colored fibers, or other identifiable, but not easily duplicatable features. This particular security paper sheet includes five contiguous blank coupons (201A, 201B, 201C, 201D, and 201E) thereon. Each of the coupons is surrounded by a tear perforations 202 along its outer perimeter.

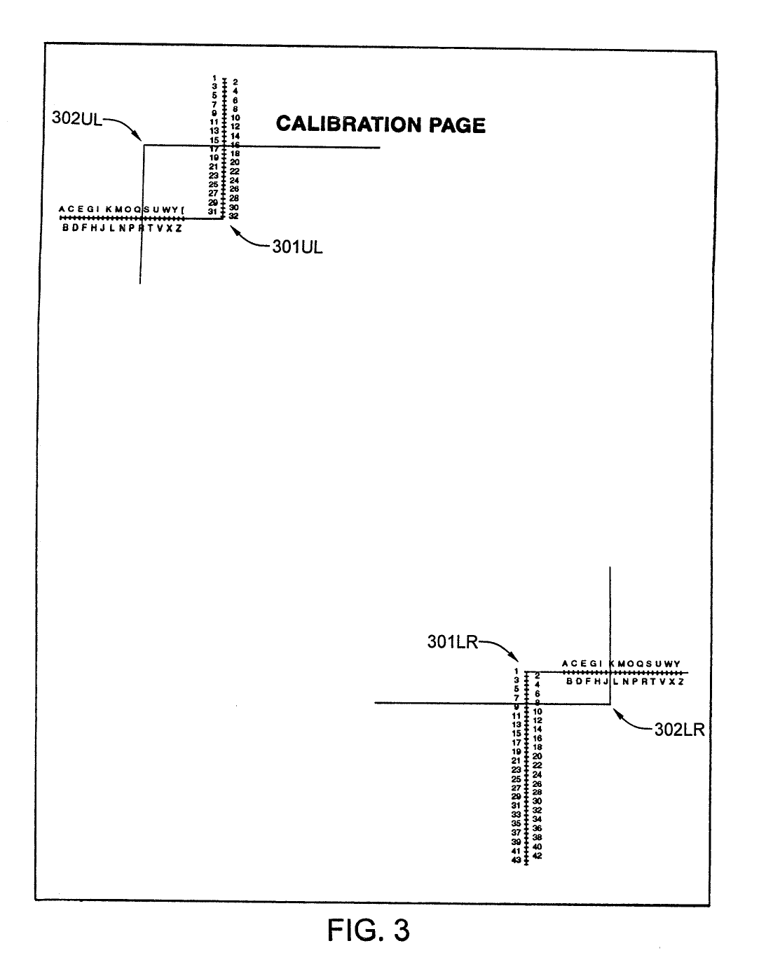

Referring now to the calibration page of FIG. 3, the subscribing consumer is asked to calibrate his printer so that the discount coupons downloaded from the server will be properly positioned on the sheets of security paper containing the blank coupons (see FIG. 2). Preprinted calibration sheets are provided to the consumer, along with the sheets of security paper. Each calibration sheet has preprinted thereon a first grid 301UL having x and y coordinates for the upper left corner of the printed block to be downloaded from the discount program server DPS, and a second grid 301LR having x and y coordinates for the lower right corner of the printed block. Calibration is accomplished by having the consumer print a test pattern on a calibration sheet provided by the program manager. The test pattern consists of two pairs of intersecting lines 302UL and 302LR, which respectively represent the upper left and lower right corner locations of a default-positioned-and-sized coupon printing field. Once the test pattern (302UL and 302LR) has been printed so that it is superimposed on the preprinted grid (301UL and 301LR), the consumer is asked to identify the two corners in terms of the alphanumeric x-y coordinates. For the case shown in FIG. 3, the upper left corner location corresponds most closely to the x-coordinate R and the y-coordinate 16. The lower left corner location, on the other hand, corresponds most closely to the x-coordinate K and the y-coordinate 8. Once this coordinate information has been made available to the server DPS, it can adjust the position and size of the coupon printing field. For a preferred embodiment of the invention, the calibration information is stored on the client system RC1, RC2, RC3 or RC4, and is uploaded to the server DPS for each printing operation.

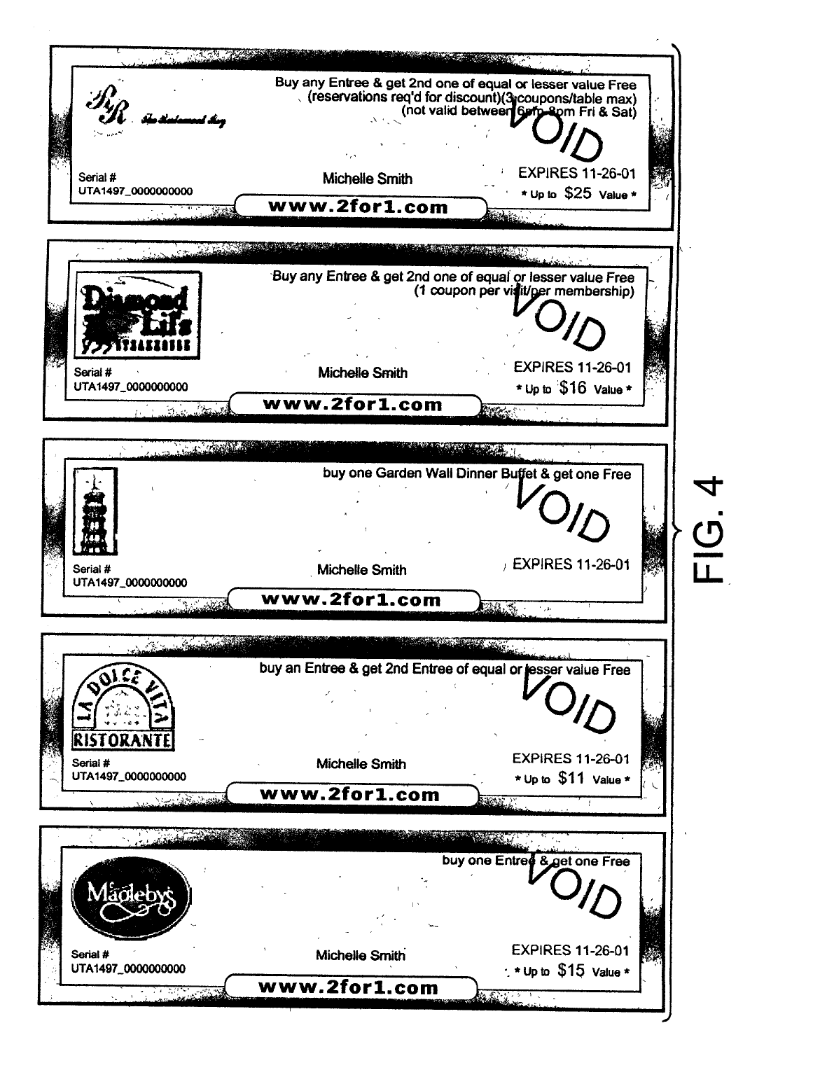

Referring now to FIG. 4, a subscribing consumer may choose to perform a trial printout of a set of coupons, in order to verify that proper calibration and formatting has taken place. The individual may indicate to the server that a printing operation will be performed as a test. Consequently, all of the discount coupons printed during the test will bear the label “VOID”. Multiple sheets of test print paper may also be provided to the registered consumers by the program manager. These sheets of test print paper are printed just like the security paper sheets, but they have neither security features such as water marks or colored fibers, nor perforations which facilitate singulation of the coupons.

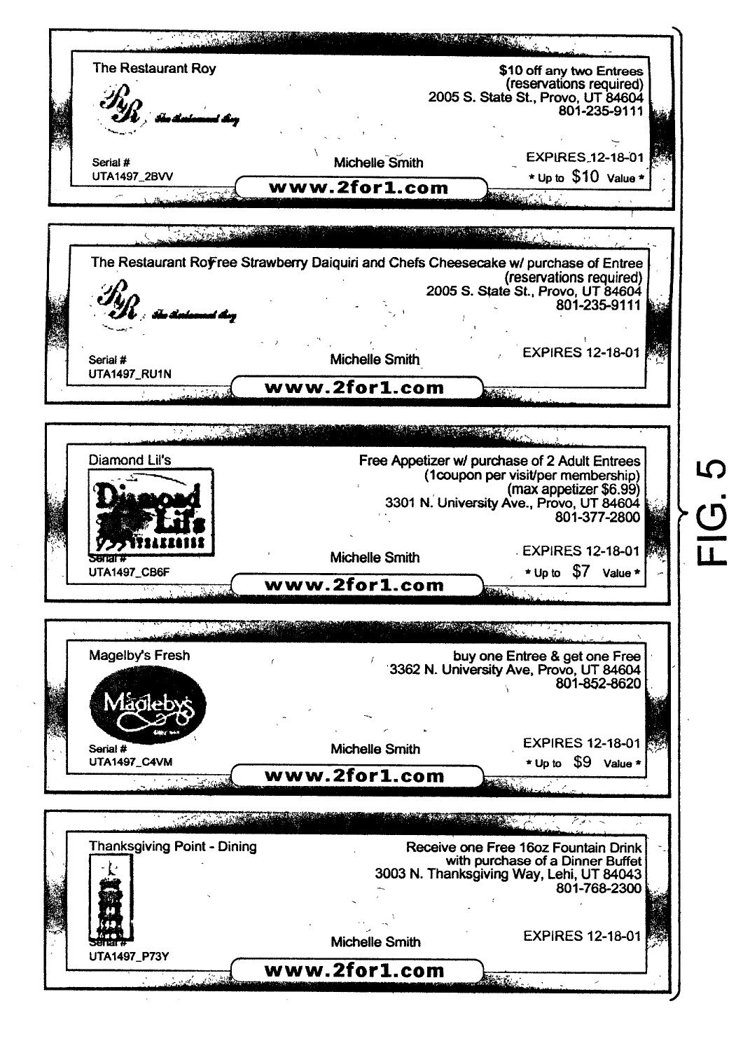

Referring now to FIG. 5, a set of five negotiable discount coupons has been printed. It will be noted that each coupon bears the name of the business offering the discount in the upper left hand corner, a serial number in the lower left-hand corner, which identifies the subscribing consumer, the name of the consumer centered at at the bottom thereof, an expiration date in the lower right-hand corner, and a description of the offered discount in the upper right-hand corner.

In response to a registered consumer's indicated interest in a particular offer, that consumer is allowed to download and print from the server system, on the security paper provided, and using a printer coupled to client system, negotiable discount coupons, each of which reflects an authorized discount offer, the number of coupons which may be printed by a single consumer for each authorized discount being limited in accordance with the restrictions imposed by the merchant.

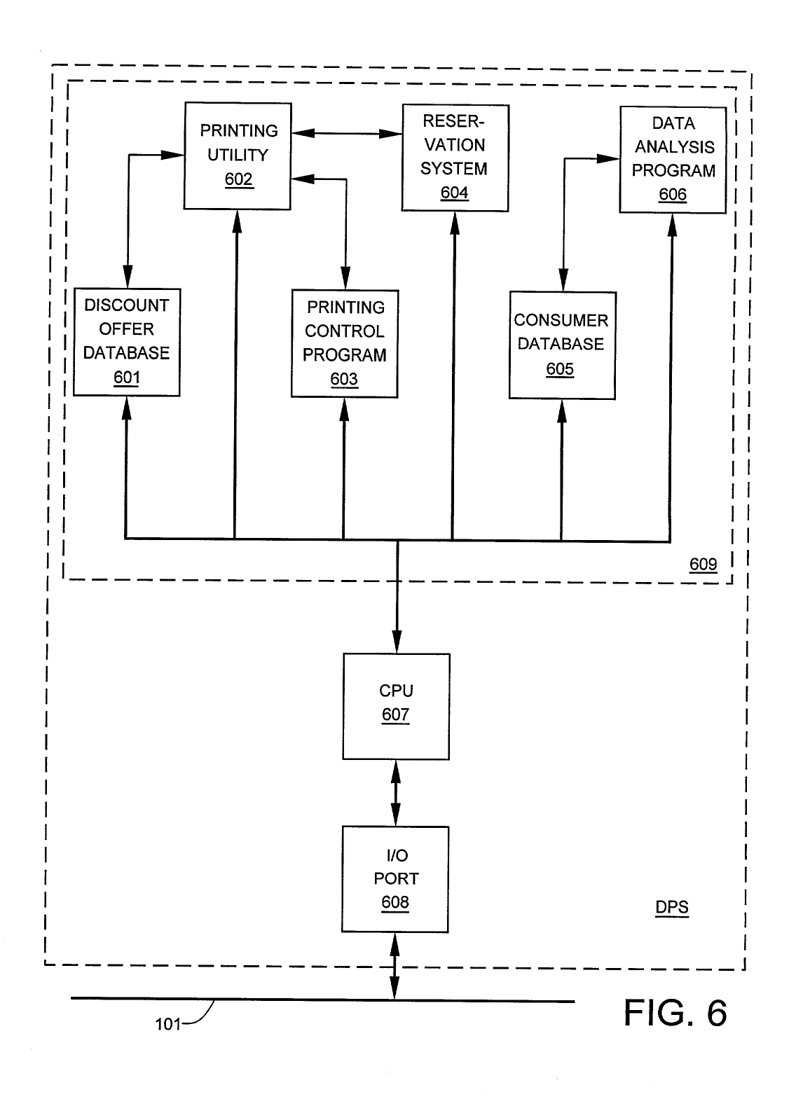

Referring now to FIG. 6, a description of the programs running on the discount program server (DPS) will now be undertaken. As heretofore states, the DPS includes an available discount offer database 601, at least some of which are subject to restrictions imposed by the authorizing merchant with regard to the number of times a single consumer may take advantage of a particular discount offer. The DPS also includes a printing utility 602, which enables registered consumers to download and print negotiable discount coupons on printers P1-P4 coupled to client systems RC1-RC4.

Still referring to FIG. 6, the method for allocating the distribution of negotiable discount coupons to individual consumers via a distributed processing network may be enhanced by providing a printing control program 603, which allows business establishments, such as restaurants, to control the number of coupons that may be printed immediately prior to or during peak business periods (e.g., Friday or Saturday evenings), so as to limit the number of coupon-bearing customers during those peak periods. Coupled with the printing control program 603 is a reservation system 604, which allows registered consumers, who are denied printing of a coupon for immediate use at a particular business, to book a reservation at that business for a weekday or for a subsequent peak period for which the maximum number of discount coupons have not yet been printed.

The invention also provides a method for tracking the use of the coupons with an on-line accessible and updatable consumer database 605 and consumer data analysis program 606, so that the buying habits of the consumers may be ascertained. Each coupon is printed with both the name of the registered consumer and a unique serial number so that it may be individually tracked by the database. The serial number also affords additional security by allowing the merchant to verify whether or not the coupon's use is authorized under the terms of its discount program. The providers of the goods and services are allowed access to the consumer database and are able to enter data related to the use of tendered coupons and view accumulated data and statistical analyses of that data. The statistical analyses afford the merchant the opportunity to better tailor its products and advertising to customer behavior.

Still referring to FIG. 6, it should be understood that this drawing figure is a simplified block diagram of server DPS, and that for the currently-preferred embodiment of the method of allocating the distribution of negotiable discount coupons, the available discount offer database 601, the printing utility 602, the printing control program 603, the reservation system 604, the consumer database, and the data analysis program 606 are all resident on a hard disk drive accessible by the server central processing unit 607. The input/output port 608, of course, couples the server to the distributed processing network 101. As part of the simplification of the block diagram of FIG. 6, the discount offer database 601 is shown as interacting bidirectionally with the printing utility 602, the printing utility 602 is shown as interacting bidirectionally with both the reservation system 604 and the printing control program 603, and the consumer database 605 is shown interacting bidirectionally with the data analysis program 606, when in reality, the central processing unit 607 orchestrates all interactions, comparisons and any updates to a particular module.

Although only a single embodiment of the method for allocating the distribution of negotiable discount coupons to individual consumers via a distributed processing network has been disclosed herein, it will be obvious to those having ordinary skill in the art that changes and modifications may be made thereto without departing from the scope and the spirit of the invention as hereinafter claimed.

What is claimed is:

1. A method for restricting the distribution of negotiable discount coupons to individual consumers via a distributed processing network, the method comprising the steps of:
providing a server computer system accessible via the network, said system having a searchable database of discount offers, authorized by various participating merchants, for the purchase of specified goods and/or services, at least some of the offers being subject to restrictions imposed by the authorizing merchant with regard to the number of times a single consumer may take advantage thereof;
establishing a pool of registered subscribing consumers, each of whom may access the server via the network and obtain the information related to available discount offers;
providing sheets of security paper to each of the subscribing consumers; and
allowing each of the subscribing consumers to download and print from the server system, on the provided security paper and using a printer coupled to the network, negotiable discount coupons, each of which reflects an authorized discount offer, the number of coupons which may be printed by a single consumer for each authorized discount being limited in accordance with the imposed restrictions.

2. The method of claim 1, wherein said distributed processing network is the Internet.

3. The method of claim 1, wherein said security paper includes perforated tear lines, which facilitate the singulation of the individual coupons.

4. The method of claim 1, wherein printing by a printer coupled to the network is preceded by a printer calibration step, performed by the consumer, which ensures that each coupon, when printed on a sheet of security paper, is properly formatted.

5. The method of claim 1, wherein each printed negotiable discount coupon includes tracking information, which identifies the subscribing consumer who printed it.

6. The method of claim 5, wherein each printed negotiable discount coupon also includes a unique serial number, by means of which the coupon may be tracked and its authorized use verified.

7. The method of claim 6, which further comprises the step of providing a database program running on the server, into which merchants, who have received discount coupons from subscribing consumers, may input coupon serial number and subscribing consumer information, said database providing verification that any tendered coupon has been used in compliance with the imposed restrictions, and further providing a statistical analysis of the purchasing habits of the subscribing consumers who have tendered discount coupons.

8. The method of claim 1, wherein said database contains information containing multiple discount offers authorized by a single merchant, said multiple offers featuring different levels of discount on the goods and/or services, the offers which feature lesser discounts also imposing fewer use restrictions.

9. A method for providing negotiable discount coupons to individual consumers via a distributed processing network, the method comprising the steps of:
providing a server computer system that is coupled to the network, and on which is stored information related to certain discounts, authorized by participating merchants, which may be applied toward the purchase of specified goods and/or services, at least one of said discounts being restricted as to the number of times an individual consumer may receive it;
establishing a pool of registered consumers, each of whom may access discount information stored on the server via any remote computer system coupled to the network;
providing sheets of security paper to each of the registered consumers; and
allowing each of the registered consumers to download and print from the server system, on the provided security paper, negotiable discount coupons, each of which reflects an authorized discount, the number of coupons which may be printed by a single consumer for each authorized discount being limited in accordance with the imposed restrictions.

10. The method of claim 9, wherein printing of the negotiable discount coupons is accomplished by a printer coupled to remote computer system.

11. The method of claim 10, wherein printing of the coupons is preceded by a printer calibration step, performed by the consumer, which ensures that each coupon, when printed on a sheet of security paper, is properly formatted.

12. The method of claim 9, wherein each printed negotiable discount coupon includes tracking information, which identifies the subscribing consumer who printed it.

13. The method of claim 12, wherein each printed negotiable discount coupon also includes a unique serial number, by means of which the coupon may be tracked and its authorized use verified.

14. The method of claim 13, which further comprises the step of providing a database program running on the server, into which merchants, who have received discount coupons from subscribing consumers, may input coupon serial number and subscribing consumer information, said database providing verification that any tendered coupon has been used in compliance with the imposed restrictions, and further providing a statistical analysis of the purchasing habits of the subscribing consumers who have tendered discount coupons.

15. The method of claim 9, wherein said security paper includes perforated tear lines, which facilitate the singulation of the individual coupons

16. The method of claim 9, wherein said database contains information containing multiple discount offers authorized by a single merchant, said multiple offers featuring different levels of discount on the goods and/or services, the offers which feature lesser discounts also imposing fewer use restrictions.

17. A method for allocating discount coupons to consumers, comprising the steps of:
enlisting at least one merchant who is willing to offer a discount on the purchase of goods and/or services to a group of identifiable consumers;
registering a group of identifiable consumers;
providing a discount offer look-up and coupon printing service accessible via a distributed processing network;
providing sheets of security paper to each of the registered consumers; and
allowing each of the registered consumers to access the service over the network, and to print negotiable discount coupons on the provided security paper, the coupon quantity printable by each registered consumer for each discount offer corresponding to that authorized by the respective merchant.

18. The method of claim 17, wherein said distributed processing network is the Internet.

19. The method of claim 17, wherein said security paper includes perforated tear lines, which facilitate the singulation of the individual coupons.

20. The method of claim 17, wherein printing by a printer coupled to the network is preceded by a printer calibration step, performed by the consumer, which ensures that each coupon, when printed on a sheet of security paper, is properly formatted on the security paper.

21. The method of claim 17, wherein each printed negotiable discount coupon includes tracking information, which identifies the subscribing consumer who printed it.

22. The method of claim 21, wherein each printed negotiable discount coupon also includes a unique serial number, by means of which the coupon may be tracked and its authorized use verified.

23. The method of claim 22, which further comprises the step of providing a database program running on the server, into which merchants, who have received discount coupons from subscribing consumers, may input coupon serial number and subscribing consumer information, said database providing verification that any tendered coupon has been used in compliance with the imposed restrictions, and further providing a statistical analysis of the purchasing habits of the subscribing consumers who have tendered discount coupons.

24. The method of claim 17, wherein said discount offer look-up and printing service contains multiple discount offers authorized by a single merchant, said multiple offers featuring different levels of discount on the goods and/or services, the offers which feature lesser discounts also imposing fewer use restrictions.

25. The method of claim 17, which further comprises the step of providing a printing control program and a reservation system, said printing control program limiting the number of negotiable discount coupons that may printed immediately prior to or during peak business periods at a particular business, said printing control program accessing said reservation system so that a consumer, who is denied printing of a coupon for immediate use at a particular business, may book a reservation at that business for a weekday or for a subsequent peak period.
